(19) United States
(12) Patent Application Publication
(10) Pub. No.: US 2026/0369672 A1
(43) Pub. Date: Nov. 19, 2026

(54) COMPOSITE SOLID ELECTROLYTE AND METHOD FOR PRODUCING SAME, CATHODE COMPOSITE COMPRISING SAME, ALL-SOLID-STATE BATTERY COMPRISING SAME

(71) Applicant: UNIVERSITY-INDUSTRY COOPERATION GROUP OF KYUNG HEE UNIVERSITY, Yongin-si (KR)

(72) Inventors: Min Sik PARK, Seoul (KR); Yoo Jin HONG, Seongnam-si (KR)

(21) Appl. No.: 19/648,777

(22) Filed: Apr. 15, 2026

(30) Foreign Application Priority Data
May 12, 2025 (KR) 10-2025-0061027

(51) Int. Cl. H01M 10/0562

(52) U.S. Cl. CPC H01M 10/0562; H01M 2300/0068

(57) ABSTRACT

Provided are a composite solid electrolyte, a method of producing the same, a cathode composite including the same, and an all-solid-state battery including the same. The composite solid electrolyte may include a core part including a sulfide-based solid electrolyte; and a shell part coated on a surface of the core part and including a functional polymer, wherein the functional polymer includes a reaction product of a hydrophobic polymer and an ion-conductive material.

### CROSS-REFERENCE TO RELATED APPLICATION

This application claims priority to Korean Patent Application No. 10-2025-0061027, filed on May 12, 2025, in the Ministry of Intellectual Property (MOIP) of the Republic of Korea, the disclosure of which is incorporated herein by reference.

### BACKGROUND OF THE DISCLOSURE

### Field of the Disclosure

The present disclosure relates to a composite solid electrolyte, a method of producing the same, a cathode composite including the same, and an all-solid-state battery including the same, and more particularly to a composite solid electrolyte into which a surface-stabilized functional coating layer (a shell part containing a functional polymer) capable of improving electrochemical properties by simultaneously securing moisture stability improvement and interfacial stability is introduced; a method of producing the same; a cathode composite including the same; and an all-solid-state battery including the same.

### Description of the Related Art

As technology development for electric vehicles and large-capacity Energy Storage Systems (ESS) has recently progressed, the demand for lithium secondary batteries having high energy density and high reliability is rapidly increasing.

Currently commercialized lithium secondary batteries are liquid electrolyte-based systems containing organic solvents, which have the advantage of high ionic conductivity, but have a risk of fire and explosion due to flammable electrolytes, and have limitations in securing stability, especially in external impact or high-temperature environments. To solve these problems, research on solid electrolyte-based all-solid-state batteries with improved safety is being actively conducted.

Solid electrolytes can be divided into sulfide-based, oxide-based, polymer-based, etc. Among them, sulfide-based solid electrolytes having high ionic conductivity and ductile mechanical properties are attracting attention.

Existing sulfide-based solid electrolytes have low moisture stability, so their structures change by reacting with moisture in the air, causing a loss of ionic conductivity, which leads to degradation of electrochemical performance. In addition, when the sulfide-based solid electrolyte reacts with moisture, hydrogen sulfide (H₂S) gas harmful to the human body is generated, so the manufacturing and assembly process must be performed in a dry room or argon atmosphere where moisture is strictly controlled. In addition, the sulfide-based solid electrolyte has a narrow electrochemical stability window, so an oxidation reaction easily occurs at high voltage, and a space charge layer is formed due to a chemical potential difference at a contact surface with a commercial cathode material, resulting in interfacial resistance and battery performance degradation.

The sulfide-based solid electrolyte for all-solid-state batteries, which is currently being studied as an alternative to overcome the energy density limit and safety problems of lithium-ion batteries, has problems of low moisture stability and an unstable interface formed upon contact with commercial cathode materials, so technology development for overcoming these limitations is essential for the commercialization of all-solid-state batteries.

Therefore, there is a need for technology development that can simultaneously improve the moisture stability and electrochemical stability of sulfide-based solid electrolytes.

### SUMMARY OF THE DISCLOSURE

Therefore, the present disclosure has been made in view of the above problems, and it is an object of the present disclosure to provide a composite solid electrolyte capable of suppressing a decrease in ionic conductivity due to structural damage even when the composite solid electrolyte is exposed to moisture can be produced by compositely coating a hydrophobic polymer and an ion-conductive material on the surface of sulfide-based solid electrolyte particles, and a method of producing the composite solid electrolyte.

It is another object of the present disclosure to provide a surface modification technology for a sulfide-based solid electrolyte capable of simultaneously improving structural stability and electrochemical performance of an all-solid-state battery by introducing a polymer-based functional coating layer on the surface of sulfide-based solid electrolyte particles to improve moisture stability and interfacial compatibility with commercial cathode materials.

It is yet another object of the present disclosure to provide a cathode composite, and an all-solid-state battery including the same, which can maintain chemical stability and improve contact between particles within an electrode when the composite solid electrolyte is composited with a commercial cathode material and applied to an all-solid-state battery.

In accordance with an aspect of the present disclosure, the above and other objects can be accomplished by the provision of a composite solid electrolyte, including: a core part including a sulfide-based solid electrolyte; and a shell part coated on a surface of the core part and including a functional polymer, wherein the functional polymer includes a reaction product of a hydrophobic polymer and an ion-conductive material.

The functional polymer may include a Si—O-A (A includes a trivalent cation) bond in a polymer matrix including the hydrophobic polymer.

The functional polymer may include a Li-A-O (A includes a trivalent cation) bond in a polymer matrix including the hydrophobic polymer.

The sulfide-based solid electrolyte may include a compound represented by Formula 1 below:

LiₐP_{b}S_{c}X_{d} [Formula 1]
where X includes at least one of Cl, Br, I, 0≤a≤12, 0≤b≤6, 0≤c≤12, and 0≤d≤9.

The hydrophobic polymer may include a compound represented by Formula 2 below:

CH₃[Si(CH₃)₂O]ₙOSi(CH₃)₃ [Formula 2]
where n is an integer of 1 to 1000.

The ion-conductive material may include a compound represented by Formula 3 below:

H₃AO₃ [Formula 3]
where A includes a trivalent cation.

A content of the functional polymer may be 0.1% by weight to 10% by weight based on the sulfide-based solid electrolyte.

In accordance with another aspect of the present disclosure, provided is a cathode composite, including: a cathode active material; the composite solid electrolyte according to an embodiment of the present disclosure; and a conductive material.

The cathode composite may have a pellet density of 3.3 to 3.4 g cm⁻³.

In accordance with still another aspect of the present disclosure, provided is an all-solid-state battery, including: the cathode composite according to an embodiment of the present disclosure; an anode; and a solid electrolyte disposed between the cathode composite and the anode.

In accordance with yet another aspect of the present disclosure, provided is a method of producing a composite solid electrolyte, the method including: preparing a sulfide-based electrolyte; producing a functional polymer solution including a functional polymer by reacting a hydrophobic polymer with an ion-conductive material in a solvent; and producing a composite solid electrolyte by reacting the sulfide-based electrolyte with the functional polymer, wherein, in the producing of the composite solid electrolyte, a shell part including the functional polymer is coated on a surface of a core part including the sulfide-based solid electrolyte.

The producing of the composite solid electrolyte may include: producing a composite solid electrolyte solution by stirring the functional polymer solution and the sulfide-based electrolyte; and heat-treating the composite solid electrolyte solution.

The heat-treating of the composite solid electrolyte solution may be performed at a temperature of 80 °C to 200 °C in a vacuum atmosphere.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic diagram illustrating a composite solid electrolyte according to an embodiment of the present disclosure;

FIG. 2 is a flowchart illustrating a method of producing the composite solid electrolyte according to an embodiment of the present disclosure;

FIG. 3 is a set of graphs illustrating the results of X-ray diffraction analysis of a solid electrolyte according to Comparative Example 1 and composite solid electrolytes according to Examples 1 to 3;

FIG. 4 is a set of graphs illustrating the results of Raman spectrum analysis of the solid electrolyte according to Comparative Example 1 and the composite solid electrolytes according to Examples 1 to 3;

FIG. 5 is a set of graphs illustrating the results of Fourier transform Infrared spectroscopy (FT-IR) analysis of the solid electrolyte according to Comparative Example 1 and the composite solid electrolytes according to Examples 1 to 3;

FIG. 6 is a set of graphs illustrating the result of X-ray photoelectron spectroscopy (XPS) analysis on the S 2p region of the solid electrolyte according to Comparative Example 1 and the composite solid electrolytes according to Examples 1 to 3, and FIG. 7 is a set of graphs illustrating the results of XPS analysis on the P 2p region of the solid electrolyte according to Comparative Example 1 and the composite solid electrolytes according to Examples 1 to 3;

FIG. 8 is a set of graphs illustrating the results of X-ray Photoelectron Spectroscopy (XPS) analysis on the Si 2p region of the solid electrolyte according to Comparative Example 1 and the composite solid electrolytes according to Examples 1 to 3, and FIG. 9 is a set of graphs illustrating the results of XPS analysis on the O 1s region of the solid electrolyte according to Comparative Example 1 and the composite solid electrolytes according to Examples 1 to 3;

FIG. 10 is a set of images illustrating the results of Scanning Electron Microscope (SEM) analysis of the solid electrolyte according to Comparative Example 1 and the composite solid electrolytes according to Examples 1 to 3;

FIG. 11 is a set of images illustrating the results of High-Resolution Transmission Electron Microscopy (HRTEM) and Energy Dispersive Spectroscopy (EDS) analysis of the solid electrolyte according to Comparative Example 1, and FIG. 12 is a set of images illustrating the results of HRTEM and EDS analysis of the composite solid electrolyte according to Example 2;

FIG. 13 is a set of images illustrating water contact angle measurement results of the solid electrolyte according to Comparative Example 1 and the composite solid electrolytes according to Examples 1 to 3;

FIG. 14 is a set of graphs illustrating the results of evaluating the hydrogen sulfide generation amount for the solid electrolyte according to Comparative Example 1 and the composite solid electrolytes according to Examples 1 to 3;

FIG. 15 is a set of graphs illustrating the ionic conductivity evaluation results of the solid electrolyte according to Comparative Example 1 and the composite solid electrolytes according to Examples 1 to 3 before and after exposure to moisture (relative humidity of 50%);

FIG. 16 is a set of graphs illustrating the results of X-ray diffraction analysis of the solid electrolyte according to Comparative Example 1 and the composite solid electrolytes according to Examples 1 to 3 after 1 hour of moisture exposure at a relative humidity of 50%, and FIG. 17 is a set of enlarged graphs illustrating the results of X-ray diffraction analysis of the solid electrolyte according to Comparative Example 1 and the composite solid electrolytes according to Examples 1 to 3 after 1 hour of moisture exposure at a relative humidity of 50%;

FIG. 18 is a set of graphs illustrating the results of Raman spectrum analysis of the solid electrolyte according to Comparative Example 1 and the composite solid electrolytes according to Examples 1 to 3 after being left for 1 hour at a relative humidity of 50%;

FIG. 19 is a set of graphs illustrating the results of X-ray photoelectron spectroscopy (XPS) analysis on the S 2p region of the solid electrolyte according to Comparative Example 1 and the composite solid electrolytes according to Examples 1 to 3 after being left for 1 hour at a relative humidity of 50%, and the degree of impurity generation represented by the area ratio of the corresponding peaks;

FIG. 20 is a set of graphs illustrating the results of X-ray photoelectron spectroscopy (XPS) analysis on the P 2p region of the solid electrolyte according to Comparative Example 1 and the composite solid electrolytes according to Examples 1 to 3 after being left for 1 hour at a relative humidity of 50%, and the degree of impurity generation represented by the area ratio of the corresponding peaks;

FIG. 21 illustrates the results of cross-sectional SEM analysis of a cathode composite according to Comparative Example 2 and cathode composites according to Examples 4-1 to 4-3;

FIG. 22 illustrates the results of mercury porosity analysis after processing the cathode composite according to Comparative Example 2 and the cathode composites according to Examples 4-1 to 4-3 into a pellet shape, and FIG. 23 illustrates the results of pellet density analysis;

FIG. 24 illustrates the results of evaluating the electrochemical properties of an all-solid-state battery according to Comparative Example 3 and all-solid-state batteries according to Examples 5-1 to 5-3;

FIG. 25 is a set of graphs illustrating the results of evaluating the lifespan characteristics of the all-solid-state battery according to Comparative Example 3 and the all-solid-state batteries according to Examples 5-1 to 5-3;

FIG. 26 is a set of graphs illustrating the results of X-ray photoelectron spectroscopy (XPS) analysis on the S 2p region at the initial stage, after the 1st cycle, and after the 100th cycle of the all-solid-state battery according to Comparative Example 3, and FIG. 27 is a set of graphs illustrating the results of X-ray photoelectron spectroscopy (XPS) analysis on the S 2p region at the initial stage, after the 1st cycle, and after the 100th cycle of the all-solid-state battery according to Example 5-2;

FIG. 28 is a set of graphs illustrating the results of evaluating the electrochemical properties of the all-solid-state battery according to Comparative Example 3 and the all-solid-state batteries according to Examples 5-1 to 5-3 after being left for 1 hour at a relative humidity of 50%;

FIG. 29 is a set of graphs illustrating the results of evaluating the lifespan characteristics of the all-solid-state battery according to Comparative Example 3 and the all-solid-state battery according to Example 5-2 after being left for 1 hour at a relative humidity of 50%; and

FIG. 30 is a set of graphs illustrating the results of impedance analysis performed after evaluating the lifespan characteristics of the all-solid-state battery according to Comparative Example 3 and the all-solid-state battery according to Example 5-2 after being left for 1 hour at a relative humidity of 50%.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the disclosure and the appended claims, the singular forms “a”, “an” and “the” are intended to include the plural forms as well, unless context clearly indicates otherwise.

Although terms used in the specification are selected from terms generally used in related technical fields, other terms may be used according to technical development and/or due to changes, practices, priorities of technicians, etc. Therefore, it should not be understood that terms used below limit the technical spirit of the present disclosure, and it should be understood that the terms are exemplified to describe embodiments of the present disclosure.

Also, some of the terms used herein may be arbitrarily chosen by the present applicant. In this case, these terms are defined in detail below. Accordingly, the specific terms used herein should be understood based on the unique meanings thereof and the whole context of the present disclosure.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Meanwhile, in the following description of the present disclosure, a detailed description of known functions and configurations incorporated herein will be omitted when it may make the subject matter of the present disclosure unclear. The terms used in the specification are defined in consideration of functions used in the present disclosure, and can be changed according to the intent or conventionally used methods of clients, operators, and users. Accordingly, definitions of the terms should be understood on the basis of the entire description of the present specification.

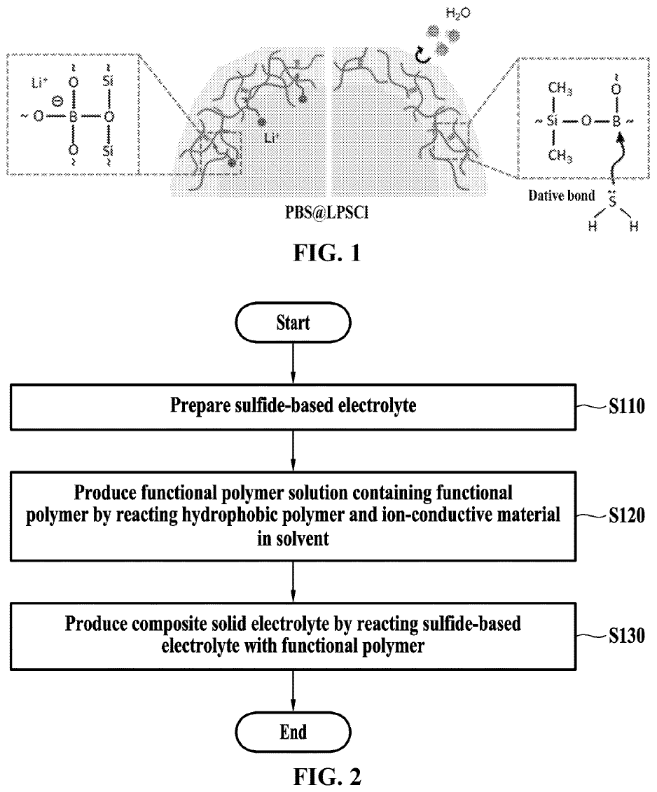

FIG. 1 is a schematic diagram illustrating a composite solid electrolyte according to an embodiment of the present disclosure.

The composite solid electrolyte according to an embodiment of the present disclosure includes a core part containing a sulfide-based solid electrolyte; and a shell part coated on a surface of the core part and containing a functional polymer, wherein the functional polymer includes a reaction product of a hydrophobic polymer and an ion-conductive material.

Although technologies for modifying sulfide-based solid electrolytes to simultaneously improve moisture stability and electrochemical stability (e.g., research on improving moisture stability by coating a polymer having water resistance or hydrophobicity and capable of lithium ion conduction on a surface of a sulfide-based solid electrolyte) have been studied, they have a limitation in that improvements in interfacial stability and contact within an electrode have not been confirmed.

Accordingly, the composite solid electrolyte according to an embodiment of the present disclosure may suppress a decrease in ionic conductivity due to structural damage after exposure to moisture by complexly coating a hydrophobic polymer and an ion-conductive material on a surface of sulfide-based solid electrolyte particles.

Specifically, the composite solid electrolyte according to an embodiment of the present disclosure may suppress contact between the sulfide-based solid electrolyte of the core part and moisture in the atmosphere through hydrophobic properties, and conduction of lithium ions is possible through a Li-A-O (e.g., Li—B—O) bond. This has an effect of improving an ionic conductivity retention rate after the sulfide-based solid electrolyte is exposed to moisture, and may improve electrochemical performance compared to existing sulfide-based solid electrolyte materials by improving interfacial stability when complexed with a commercial cathode material and introduced into an all-solid-state battery.

In addition, the composite solid electrolyte according to an embodiment of the present disclosure has an effect of improving contact between a cathode and a solid electrolyte in an electrode due to a shell part (e.g., functional coating layer) containing a viscoelastic functional polymer, thereby suppressing pore formation in the electrode and contributing to increasing pellet density.

Therefore, the composite solid electrolyte according to an embodiment of the present disclosure is a solid electrolyte capable of improving existing sulfide-based solid electrolytes, and may be widely used in various fields such as secondary batteries, all-solid-state batteries, and next-generation energy storage systems.

Hereinafter, each component of the composite solid electrolyte according to an embodiment of the present disclosure will be described in more detail.

The composite solid electrolyte according to an embodiment of the present disclosure may include a core part containing a sulfide-based solid electrolyte.

The sulfide-based solid electrolyte may include sulfide-based solid electrolyte particles.

When the composite solid electrolyte according to an embodiment of the present disclosure is applied in a cathode composite, the cathode composite needs to be mixed with a powder-type cathode active material. Accordingly, the composite solid electrolyte, and a conductive material, process suitability may be improved by using sulfide-based solid electrolyte particles as the sulfide-based solid electrolyte included in the composite solid electrolyte.

In addition, when producing a composite solid electrolyte using a sulfide-based solid electrolyte thin film rather than a particulate sulfide-based solid electrolyte, it is difficult to effectively control a space charge layer and interfacial side reactions occurring between two particles due to structural characteristics in which active material particles and solid electrolyte particles are mixed in a cathode composite.

On the other hand, the composite solid electrolyte according to an embodiment of the present disclosure may secure interfacial stability at a contact interface with active material particles in the cathode composite by forming a coating layer on the particulate sulfide-based solid electrolyte.

The composite solid electrolyte according to an embodiment of the present disclosure may have ionic conductivity controlled according to a diameter of the sulfide-based solid electrolyte particles.

For example, when the diameter of the sulfide-based solid electrolyte particles is increased, ionic conductivity may be increased. However, since tortuosity of an ion conduction path increases and electrochemical performance degrades, the diameter of the sulfide-based solid electrolyte particles should be appropriately controlled.

For example, the diameter of the sulfide-based solid electrolyte particles may be 0.7 μm to 3 μm. If the diameter of the sulfide-based solid electrolyte particles is less than 0.7 μm, there is a problem that ionic conductivity of the solid electrolyte itself decreases due to degradation of crystallinity of particles, and if it exceeds 3 μm, ionic conductivity of the solid electrolyte itself increases, but there is a problem that electrochemical performance degrades because voids in the cathode composite increase and a contact area with the cathode active material decreases, so tortuosity of the ion conduction path increases.

The sulfide-based solid electrolyte contains sulfur(S), has ion conductivity of a metal belonging to Group 1 or Group 2 of the periodic table, and may include Li—P—S based glass or Li—P—S based glass ceramic.

For example, sulfide-based solid electrolyte may include at least one of Li₆PS₅Cl, Li₆PS₅Br, Li₆PS₅I, Li₂S—P₂S₅, Li—P₃S₁₁, Li₃PS₄, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂S₅, Li₂S—P₂S₅—SiS₂, Li₂S—P₂S₅—SnS, Li₂S—P₂S₅—Al₂S₃, Li₂S—GeS₂ and Li₂S—GeS₂—ZnS.

In addition, the sulfide-based solid electrolyte may be in a form doped with trace elements, for example, Li₆PS₅Cl additionally doped with bromine (Br).

Preferably, the sulfide-based solid electrolyte may include a compound represented by Formula 1 below:

LiₐP_{b}S_{c}X_{d} [Formula 1]

(In Formula 1, X includes at least one of Cl, Br, I, 0≤a≤12, 0≤b≤6, 0≤c≤12, and 0≤d≤9)

More preferably, the sulfide-based solid electrolyte may include at least one of Li₆PS₅Cl, Li₆PS₅Br, Li₆PS₅I, Li₂S—P₂S₅, Li₂P₃S₁₁ and Li₃PS₄.

Li₆PS₅Cl, Li₆PS₅Br and Li₆PS₅I may be argyrodite-type solid electrolyte.

A content of the sulfide-based solid electrolyte may be 90% by weight to 99.5% by weight based on 100% by weight of the composite solid electrolyte. When the content of the sulfide-based solid electrolyte is less than 90% by weight, there is a problem that ionic conductivity of the composite solid electrolyte decreases because a content of the functional polymer having relatively lower ionic conductivity than the sulfide-based solid electrolyte increases. When it exceeds 99.5% by weight, there is a problem that it is difficult to confirm improvements in moisture stability and interfacial stability because the functional polymer content relatively decreases.

Finally, the composite solid electrolyte according to an embodiment of the present disclosure includes a shell part coated on a surface of the core part and containing a functional polymer.

The shell part may serve as a buffer layer, and the functional polymer included in the shell part includes a reaction product of a hydrophobic polymer and an ion-conductive material.

If the shell part is formed as separate layers rather than a reaction product of the hydrophobic polymer and the ion-conductive material, processes become complicated and manufacturing efficiency decreases because each layer needs to be formed individually. In addition, if different materials exist in a layered structure, unexpected chemical reactions may occur at the interface, which may disturb movement of lithium ions or cause an increase in interfacial resistance.

On the other hand, the shell part of the composite solid electrolyte according to an embodiment of the present disclosure contains a functional polymer including a reaction product of a hydrophobic polymer and an ion-conductive material, so that contact between the solid electrolyte and moisture may be blocked, generation of hydrogen sulfide gas may be suppressed, and loss of ionic conductivity may be minimized.

In addition, the shell part plays a role of blocking H₂S generated when in contact with moisture and, at the same time, prevents H₂S from being released to the outside even if generated, so it is stable even when exposed to moisture for a long time, and thus moisture stability of the composite solid electrolyte may be improved.

Accordingly, the composite solid electrolyte according to an embodiment of the present disclosure may improve the electrochemical performance of the all-solid-state battery and secure technological competitiveness for next-generation high-energy-density lithium secondary battery technology.

The hydrophobic polymer may serve as a polymer matrix in the functional polymer.

The hydrophobic polymer may include at least one of polyethylene, polyethylene oxide, polyethylene glycol, polypropylene oxide, polymethyl methacrylate, polydimethylsiloxane, polyvinylpyrrolidinone, polyacrylonitrile, styrene-butadiene copolymer, acrylonitrile-butadiene copolymer, polystyrene, polyvinyl chloride, polycarbonate (bisphenol A), Nylon 66, and polyether-urethane.

Preferably, the hydrophobic polymer may include a compound represented by Formula 2 below:

CH₃[Si(CH₃)₂O]ₙOSi(CH₃)₃ [Formula 2]

(In Formula 2, n is an integer of 1 to 1000.)

The composite solid electrolyte according to an embodiment of the present disclosure may have ionic conductivity controlled according to the content of the hydrophobic polymer.

The content of the hydrophobic polymer may be 30% by weight to 70% by weight based on 100% by weight of the functional polymer. When the content of the hydrophobic polymer is less than 30% by weight, there is a problem that it is difficult to suppress contact between the composite solid electrolyte and moisture because the hydrophobic properties of the functional polymer degrade. When it exceeds 70% by weight, there is a problem that the ionic conductivity of the composite solid electrolyte decreases because the content of the ion-conductive material relatively decreases.

The ion-conductive material forms a Si—O—B bond by undergoing a condensation reaction with a terminal group of the hydrophobic polymer, thereby being capable of being synthesized into a functional polymer-based coating layer (corresponding to the shell part). Introduction of such an ion-conductive material may contribute to mitigating interfacial resistance of the composite solid electrolyte and improving ion conduction characteristics by providing a transport path for lithium ions inside the functional polymer.

The ion-conductive material may include a compound represented by Formula 3 below:

H₃AO₃ [Formula 3]

(In Formula 3, A includes a trivalent cation.)

The trivalent cation may include at least one of B, Al, Ga, In, Tl, La, Ce, Nd, Sm, Eu, Gd, Dy, Cr, Fe and Co.

The trivalent cation may accept a lone pair of electrons of oxygen, and may form a Si—O-A bond through a condensation reaction with a terminal group of the hydrophobic polymer.

The trivalent cation may contribute to moisture stability, interfacial stability, improvement of mechanical strength, or formation of an ion conduction path in a polymer network through formation of an [AO₄] unit.

Preferably, the trivalent cation may include at least one of B and Al.

For example, when H₃BO₃ is used as an ion-conductive material, the composite solid electrolyte according to an embodiment of the present disclosure may exhibit a peak corresponding to a B—O bond of the functional polymer in a region of 1450 to 1480, a peak corresponding to Si—CH₃ in a region of 1262 to 1272, a peak corresponding to a Si—O bond in a region of 1150 to 1100, a peak corresponding to Si—O—B in a region of 870 to 900, and a peak corresponding to Si—C at a wavenumber of 807.

Both H₃BO₃ and H₃AlO₃ are trivalent cation-based precursors, and may form Si—O—B and Si—O—Al bonds, respectively, through a condensation reaction with terminal Si—OH groups of the functional polymer. Such a bond structure may enable chemical connection between polymer chains.

According to an embodiment, the functional polymer may include a Si—O-A (wherein A includes a trivalent cation) bond in a polymer matrix containing the hydrophobic polymer.

Specifically, a Si—O-A bond may be formed through a condensation reaction between a terminal group of the hydrophobic polymer, which constitutes the functional polymer, and the ion-conductive material. Through this reaction, the hydrophobic polymer and the ion-conductive material are connected in a form of a covalent bond, which means that the two materials are integrated into one continuous polymer network.

For example, when H₃BO₃ is used as the ion-conductive material, a peak corresponding to a Si—O—B bond may appear at 102.2.

According to an embodiment, the functional polymer may include a Li-A-O (wherein A includes a trivalent cation) bond in a polymer matrix containing the hydrophobic polymer.

Specifically, B in the functional polymer may form a [BO₄]⁻ structure while accepting a lone pair of electrons of O existing in another adjacent chain, and the structure may interact with lithium ions on a surface of the sulfide-based solid electrolyte to form a Li—B—O bond.

Since this Li—B—O bond has a relatively weak interaction, lithium ions may move between [BO₄]⁻ units through a hopping mechanism, and consequently, an ion conduction path may be formed even within the functional polymer.

For example, when H₃BO₃ is used as the ion-conductive material, a peak corresponding to a Li—B—O bond may appear at 531.0.

The content of the ion-conductive material may be 30% by weight to 70% by weight based on 100% by weight of the functional polymer. When the content of the ion-conductive material is less than 30% by weight, there is a problem that ionic conductivity of the composite solid electrolyte decreases because Li—B—O bonds that can be formed in the functional polymer decrease. When it exceeds 70% by weight, there is a problem that it is difficult to suppress contact between the composite solid electrolyte and moisture because the content of the hydrophobic polymer relatively decreases.

The content of the functional polymer may be 0.1% by weight to 10% by weight relative to the sulfide-based solid electrolyte. When the content of the functional polymer is less than 0.1% by weight relative to the sulfide-based solid electrolyte, there is a problem that the effect of improving moisture stability and interfacial stability of the solid electrolyte may be insufficient because the surface coating layer of the sulfide-based solid electrolyte is discontinuous or fails to sufficiently cover the surface thereof. When it exceeds 10% by weight, there is a problem that interfacial resistance and electrochemical performance degrade because diffusion resistance of lithium ions increases and ionic conductivity of the composite solid electrolyte decreases as a thickness of the coating layer becomes excessively thick.

For example, the functional polymer, which is a reaction product of the hydrophobic polymer and the ion-conductive material, may include a compound represented by Formula 4 below:

CH₃—[Si(CH₃)₂—O-A(OH)—O]ₙ—Si(CH₃)₃ [Formula 4]

(In Formula 4, A includes a trivalent cation.)

The composite solid electrolyte according to an embodiment of the present disclosure may have ionic conductivity controlled according to a thickness of the shell part (corresponding to the coating layer).

The thickness of the shell part may be 5 nm to 20 nm. When the thickness of the shell part is less than 5 nm, there is a problem that the effect of improving moisture stability and interfacial stability of the sulfide-based solid electrolyte may be insufficient because the coating layer is discontinuous or fails to sufficiently cover the surface thereof. When it exceeds 20 nm, there is a problem that electrochemical performance degrades because ionic conductivity of the composite solid electrolyte material decreases.

The composite solid electrolyte according to an embodiment of the present disclosure may improve safety and electrochemical performance of a battery by introducing the shell part (e.g., a functional coating layer) containing the functional polymer to simultaneously enable improvement of moisture stability and securing of interfacial stability.

When the composite solid electrolyte according to an embodiment of the present disclosure is left for 30 minutes to 2 hours at 50% relative humidity, a generation amount of hydrogen sulfide may be 70 ppm to 50 ppm.

Therefore, the composite solid electrolyte according to an embodiment of the present disclosure may be critically applied to development of a next-generation high-energy-density all-solid-state lithium secondary battery capable of simultaneously implementing high energy density and high safety, and may be expanded and applied to various application fields such as electric vehicles and ESS in the future.

Hereinafter, a cathode composite according to an embodiment of the present disclosure including the composite solid electrolyte according to an embodiment of the present disclosure will be described in detail.

The cathode composite according to an embodiment of the present disclosure may include a cathode active material, a composite solid electrolyte and a conductive material.

The composite solid electrolyte may include the composite solid electrolyte according to an embodiment of the present disclosure.

Therefore, when the composite solid electrolyte according to an embodiment of the present disclosure is complexed with a commercial cathode material and applied to an all-solid-state battery, the cathode composite according to an embodiment of the present disclosure may improve reliability of a multifunctional composite solid electrolyte material capable of realizing improved electrochemical performance compared to existing sulfide-based solid electrolyte materials.

In addition, in the cathode composite according to an embodiment of the present disclosure, an improvement of contact between particles in an electrode utilizing the shell part using the functional polymer may act advantageously for high-density electrode design, and thus may contribute to an improvement of energy density.

The cathode active material is not particularly limited, but may include a lithium transition metal oxide capable of adsorbing and releasing lithium ions.

For example, the cathode active material may include at least one of an NCM (nickel, cobalt, element M)-based lithium composite oxide, an NCA (nickel, cobalt, aluminum)-based lithium composite oxide, an NCMA (nickel, cobalt, element M, aluminum)-based lithium composite oxide, a lithium composite oxide of manganese and nickel such as LiMn_{1.5}Ni_{0.5}O₄, lithium titanate, lithium cobaltate (lithium cobalt oxide), lithium nickelate, lithium manganate, titanium oxide, niobium oxide, tungsten oxide, molybdenum oxide, and a lithium metal phosphate such as LiMPO₄ (M=Fe, Mn, Co, Ni) and Li₃V₂(PO₄)₃.

In the NCM-based lithium composite oxide and the NCMA-based lithium composite oxide, the element M may include at least one of Na, Mg, Ca, Y, Ti, Zr, Hf, V, Nb, Ta, Cr, Mo, W, Mn, Fe, Cu, Ag, Zn, B, Al, Ga, C, Si, Sn, Ba, and Zr.

The content of the cathode active material may be 60% by weight to 85% by weight based on 100% by weight of the cathode composite. When the content of the cathode active material is less than 60% by weight, there is a problem that capacity and energy density degrade because a ratio of materials participating in an electrochemical reaction decreases. When it exceeds 85% by weight, there is a problem that securing a continuous ion conduction path in the cathode composite becomes difficult and a degradation of cathode utilization and electrochemical performance occurs because the content of the solid electrolyte relatively decreases.

The composite solid electrolyte may include the composite solid electrolyte according to an embodiment of the present disclosure.

Since the composite solid electrolyte includes the same components as the composite solid electrolyte according to an embodiment of the present disclosure described with reference to FIG. 1, a detailed description thereof will be omitted.

The content of the composite solid electrolyte may be from 14% by weight to 35% by weight based on 100% by weight of the cathode composite. When the content of the composite solid electrolyte is less than 14% by weight, composite solid electrolyte particles in the cathode composite are not sufficiently dispersed among the cathode active material, making it difficult to secure a continuous ion conduction path. This decreases cathode utilization and increases the region of the cathode active material that cannot participate in the electrochemical reaction, resulting in degraded electrochemical performance. When it exceeds 35% by weight, the content of the cathode active material relatively decreases, causing reduced capacity and energy density.

The conductive material may include at least one of active carbon, carbon nanotube, carbon fiber, graphene, graphite, carbon black, acetylene black, ketjen black, Super P, Super C, metal nanowire, and metal nanopowder.

The content of the conductive material may be from 1% by weight to 5% by weight based on 100% by weight of the cathode composite. When the content of the conductive material is less than 1% by weight, a continuous electron transfer path is not formed in the cathode composite, which lowers conductivity and degrades electrochemical performance. When it exceeds 5% by weight, the active material content relatively decreases, reducing capacity and energy density, and excessive conductive material may obstruct the ion conduction path between the solid electrolyte and the active material.

The cathode composite according to an embodiment of the present disclosure may have a pellet density of 3.3 g cm⁻³ to 3.4 g cm⁻³. When the pellet density is less than 3.3 g cm⁻³, the porosity within the pellet increases, making the contact between the solid electrolyte and the cathode active material insufficient. This may cause the lithium ion conduction path to be disconnected or resistance to increase, resulting in degraded electrochemical performance. When it exceeds 3.3 g cm⁻³, excessive pressure is applied during pellet formation, which may cause cracks in the cathode active material particles, resulting in degraded structural stability during long-term cycling.

In the cathode composite according to an embodiment of the present disclosure, the shell part flexibly deforms according to external pressure during the process of compressing the cathode composite to manufacture a pellet due to the viscoelastic properties of the shell part of the composite solid electrolyte, effectively filling the gaps between particles.

As a result, the porosity inside the pellet decreases, and the effect of increasing the overall pellet density may be obtained.

Hereinafter, an all-solid-state battery according to an embodiment of the present disclosure including the cathode composite according to an embodiment of the present disclosure will be described in detail.

The all-solid-state battery according to an embodiment of the present disclosure includes the cathode composite according to an embodiment of the present disclosure, an anode, and a solid electrolyte disposed between the cathode composite and the anode.

Since the cathode composite includes the same components as the cathode composite according to an embodiment of the present disclosure, a detailed description thereof will be omitted.

When using a metal itself, the anode may be manufactured by a method of using a metal thin film itself or physically bonding, rolling, or depositing a metal on an anode current collector.

The metal that is the metal thin film itself or is bonded/rolled/deposited on an anode current collector may include at least one of lithium (Li), nickel (Ni), tin (Sn), copper (Cu), and indium (In).

The solid electrolyte may include a sulfide-based solid electrolyte.

It may be the same as or different from the sulfide-based solid electrolyte included in the cathode composite included in the all-solid-state battery according to an embodiment of the present disclosure.

The all-solid-state battery according to an embodiment of the present disclosure may further include a liquid electrolyte when necessary to be utilized as a semi-solid battery. In this case, a separate polymer separator may be further required.

The all-solid-state battery according to an embodiment of the present disclosure includes the composite solid electrolyte to which the shell part is applied, thereby improving interfacial stability between the cathode composite and the solid electrolyte, which may improve electrochemical performance.

Hereinafter, a method of producing the composite solid electrolyte according to an embodiment of the present disclosure will be described in detail with reference to FIG. 2.

FIG. 2 is a flowchart illustrating a method of producing the composite solid electrolyte according to an embodiment of the present disclosure.

The method of producing the composite solid electrolyte according to an embodiment of the present disclosure includes a step (S110) of preparing a sulfide-based electrolyte, preparing a functional polymer solution including a functional polymer by reacting a hydrophobic polymer and an ion-conductive material in a solvent (S120), and a step (S130) of producing a composite solid electrolyte by reacting the sulfide-based electrolyte with the functional polymer.

Therefore, the method of producing the composite solid electrolyte according to an embodiment of the present disclosure may secure flexibility in the production process by using the composite solid electrolyte according to an embodiment of the present disclosure having improved moisture stability. Furthermore, it may enhance reliability in an actual use environment, such as long-term cycle stability and reduction of interfacial resistance.

First, the method of producing the composite solid electrolyte according to an embodiment of the present disclosure proceeds with the step (S110) of preparing a sulfide-based electrolyte.

Since the sulfide-based electrolyte is the same as described in the composite solid electrolyte according to an embodiment of the present disclosure, a detailed description thereof will be omitted.

Next, the method of producing the composite solid electrolyte according to an embodiment of the present disclosure proceeds with the step (S120) of preparing a functional polymer solution including a functional polymer by reacting a hydrophobic polymer and an ion-conductive material in a solvent.

The solvent may include at least one of tetrahydrofuran (THF), ethyl acetate, acetone, dimethyl sulfoxide (DMSO), dimethylformamide (DMF), acetonitrile, propionitrile, 3-chloropropionitrile, benzonitrile, 4-fluorobenzonitrile, tertiary-butyronitrile, isobutyronitrile, cyclohexylnitrile, capronitrile, isocapronitrile, malononitrile, dibutyl ether (DBE), propylene carbonate (PC), and trifluorotoluene.

Since the hydrophobic polymer and the ion-conductive material are the same as described in the composite solid electrolyte according to an embodiment of the present disclosure, a detailed description thereof will be omitted.

The step (S120) of preparing a functional polymer solution may be performed using a first stirring process of stirring the hydrophobic polymer and the ion-conductive material in a solvent.

The stirring speed of the first stirring process may be 100 rpm to 400 rpm. When the stirring speed is less than 100 rpm, the dispersion of the hydrophobic polymer and the ion-conductive material is not smooth, resulting in a problem that the functional polymer solution is formed unevenly. When it exceeds 400 rpm, there is a problem that the solution splashes on the wall of a container or the solution is lost.

A stirring time of the first stirring process may be 1 hour to 3 hours. When the stirring time is less than 1 hour, the hydrophobic polymer and the ion-conductive material are not sufficiently dissolved in the solvent, resulting in a problem that the uniformity of the coating layer composition may not be secured in a subsequent process. When it exceeds 3 hours, the overall process time increases while additional advantages such as increased solubility are not significant.

Finally, the method of producing the composite solid electrolyte according to an embodiment of the present disclosure proceeds with the step (S130) of producing a composite solid electrolyte by reacting the sulfide-based electrolyte with the functional polymer.

The step (S130) of producing a composite solid electrolyte may be performed using a second stirring process of stirring the functional polymer solution and the sulfide-based electrolyte.

Therefore, in the step (S130) of producing a composite solid electrolyte, the shell part including the functional polymer is coated on the surface of the core part including the sulfide-based solid electrolyte.

Depending on the embodiment, the step (S130) of producing a composite solid electrolyte may include a step (S131) of producing a composite solid electrolyte solution by stirring a functional polymer solution and a sulfide-based electrolyte, and a step (S132) of heat-treating the composite solid electrolyte solution.

The step (S131) of producing a composite solid electrolyte solution may be performed to remove the solvent included in the functional polymer solution.

The stirring speed of the second stirring process in the step (S131) of producing a composite solid electrolyte solution may be 100 rpm to 400 rpm. When the stirring speed is less than 100 rpm, the dispersion of the sulfide-based solid electrolyte in the solution is not smooth, resulting in a problem that the coating layer is formed unevenly. When it exceeds 400 rpm, the solution may splash or overflow onto the wall of the container, causing solution loss, and there is a problem that bubbles are mixed during stirring, hindering the uniformity of the coating.

The stirring time of the second stirring process may be 2 hours to 8 hours. When the stirring time is less than 2 hours, the sulfide-based solid electrolyte is not sufficiently dispersed in the solvent, resulting in a problem that the coating layer is formed unevenly. When it exceeds 8 hours, the sulfide-based solid electrolyte is exposed to the solvent for a long time, causing a problem that an interfacial reaction may occur or ionic conductivity may decrease.

A stirring temperature of the second stirring process may be 60 °C to 100 °C. When the stirring temperature is less than 60 °C, the evaporation rate of the solvent in the solution decreases, resulting in a problem that excessive time is required for a drying process. When it exceeds 100 °C, the solvent evaporates rapidly within a short time, inducing agglomeration before the sulfide-based solid electrolyte is uniformly dispersed in the solution, or causing a problem that the coating layer is formed unevenly.

The step (S132) of heat-treating the composite solid electrolyte solution may be performed to dry the composite solid electrolyte solution. Therefore, a bulk composite solid electrolyte may be produced in the step (S132) of heat-treating the composite solid electrolyte solution.

The step (S132) of heat-treating the composite solid electrolyte solution may be performed under a vacuum atmosphere at a temperature of 80 °C to 200 °C.

When the heat treatment temperature is less than 80 °C, there is a high possibility that the solvent remains, making it difficult to secure the structural stability of the coating layer, and causing problems of decreased ionic conductivity and inducing interfacial reactions. When it exceeds 200 °C, there is a possibility that thermal decomposition of the coating layer may begin, and there is a problem that the structural stability of the sulfide-based solid electrolyte may also be hindered.

The heat treatment time may be 1 hour to 6 hours. When the heat treatment time is less than 1 hour, there is a high possibility that the solvent remains, making it difficult to secure the structural stability of the coating layer, and causing problems of decreased ionic conductivity and inducing interfacial reactions. When it exceeds 6 hours, the structural stability of the sulfide-based solid electrolyte may be hindered, and there is a problem of degraded process efficiency.

Depending on the embodiment, the method of producing the composite solid electrolyte according to an embodiment of the present disclosure may proceed with the step (S132) of heat-treating the composite solid electrolyte solution, and then proceed with a step (S133) of obtaining a composite solid electrolyte by pulverizing the bulk composite solid electrolyte.

The step (S133) of obtaining a composite solid electrolyte may be performed through a pulverization process after cooling the bulk composite solid electrolyte, obtained in the step (S132) of heat-treating the composite solid electrolyte solution, to room temperature (15 °C to 25 °C).

Hereinafter, embodiments of the present disclosure will be described in detail so that those of ordinary skill in the art to which the present disclosure pertains can easily carry them out. However, the present disclosure may be implemented in various different forms and is not limited to the embodiments described herein.

### [Experimental Example 1] Evaluation of Properties of Composite Solid Electrolyte

### Comparative Example 1

Core particles containing Li₆PS₅Cl were prepared.

### Example 1

A functional polymer solution was prepared by stirring PDMS and H₃BO₃ at a weight ratio of 1:1 in dibutyl ether, and then adding it at 0.5% by weight based on the core particles of Li₆PS₅Cl. Next, the core particles of Comparative Example 1 and the functional polymer solution were stirred at 400 rpm for 1 hour to remove the dibutyl ether, and heat treatment was performed at 120 °C in a vacuum oven. Next, the fired product was cooled and pulverized to obtain a composite solid electrolyte.

### Example 2

A functional polymer solution was manufactured in the same manner as in Example 1, except that the functional polymer solution was added in an amount of 1% by weight based on the core particles of Li₆PS₅Cl.

### Example 3

A functional polymer solution was manufactured in the same manner as in Example 1, except that the functional polymer solution was added in an amount of 2% by weight based on the core particles of Li₆PS₅Cl.

Specifically, Comparative Example 1 and Examples 1 to 3 were manufactured as shown in Table 1 below.

TABLE 1

| | | wt % of core | wt % of PDMS | wt % of H₃BO₃ | | | |
|---|---|---|---|---|---|---|---|
| | Sulfide- | material of | based on total | based on total | | | |
| | based | composite | weight of | weight of | | | Heat |
| | solid | solid | composite solid | composite solid | | Drying | treatment |
| | electrolyte | electrolyte | electrolyte | electrolyte | Solvent | temperature | temperature |
| Comparative | Li₆PS₅Cl | 100% | — | — | — | — | — |
| Example 1 | | | | | | | |
| Example 1 | Li₆PS₅Cl | 99.50% | 0.25% | 0.25% | Dibutyl | 80 °C | 120 °C |
| | | | | | ether | | |
| Example 2 | Li₆PS₅Cl | 99% | 0.50% | 0.50% | Dibutyl | 80 °C | 120 °C |
| | | | | | ether | | |
| Example 3 | Li₆PS₅Cl | 98% | 1% | 1% | Dibutyl | 80 °C | 120 °C |
| | | | | | ether | | |

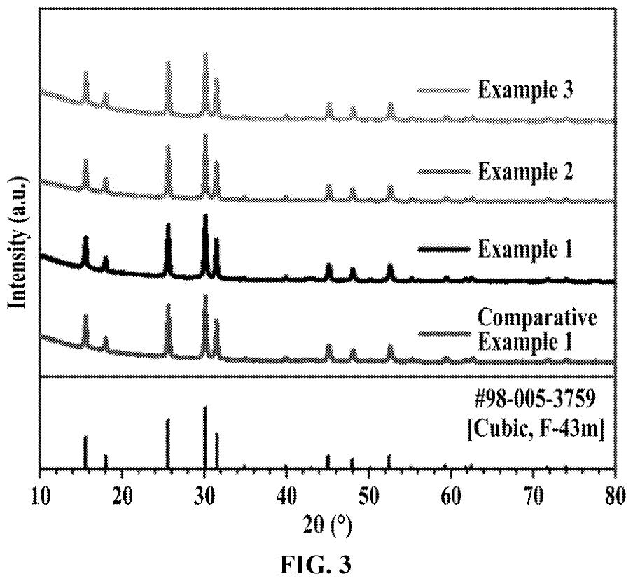

FIG. 3 is a set of graphs illustrating the results of X-ray diffraction analysis of the solid electrolyte according to Comparative Example 1 and the composite solid electrolytes according to Examples 1 to 3.

Referring to FIG. 3, an existing Li₆PS₅Cl crystal structure (Cubic, F-43m) could be confirmed, and it was confirmed that there was no significant structural difference in the composite solid electrolytes according to Examples 1 to 3 compared to the solid electrolyte according to Comparative Example 1, and no additional impurities were formed.

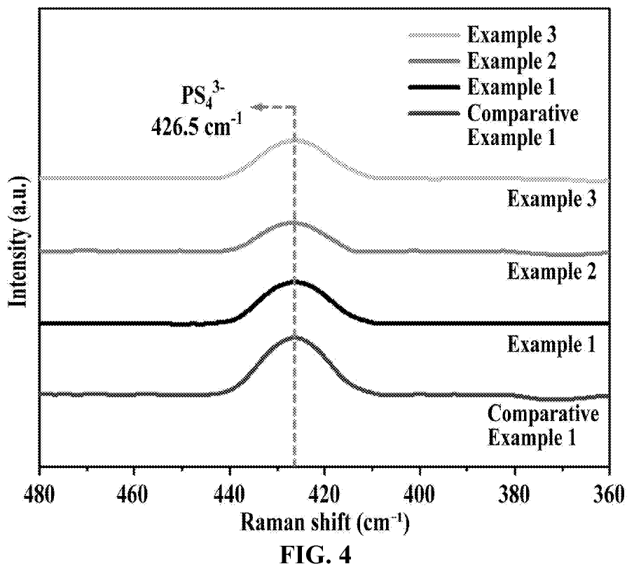

FIG. 4 is a set of graphs illustrating the results of Raman spectrum analysis of the solid electrolyte according to Comparative Example 1 and the composite solid electrolytes according to Examples 1 to 3.

Referring to FIG. 4, it was confirmed that there was no significant difference in the PS₄³⁻ bonding of the composite solid electrolytes according to Examples 1 to 3 compared to the solid electrolyte according to Comparative Example 1.

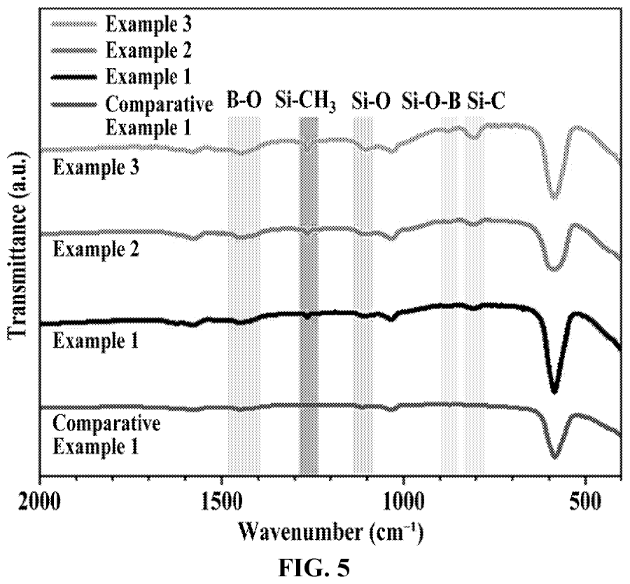

FIG. 5 is a set of graphs illustrating the results of Fourier transform Infrared spectroscopy (FT-IR) analysis of the solid electrolyte according to Comparative Example 1 and the composite solid electrolytes according to Examples 1 to 3.

Referring to FIG. 5, it was confirmed that B—O (1450-1480 cm⁻¹), Si—CH₃ (1272-1262 cm⁻¹), Si—O (1150-1100 cm⁻¹), Si—O—B (870-900 cm⁻¹), and Si—C(807 cm⁻¹) bonds were formed for the solid electrolyte according to Comparative Example 1 and the composite solid electrolytes according to Examples 1 to 3, respectively. From this, it can be confirmed that a functional coating layer was introduced on the surface of the sulfide-based solid electrolyte.

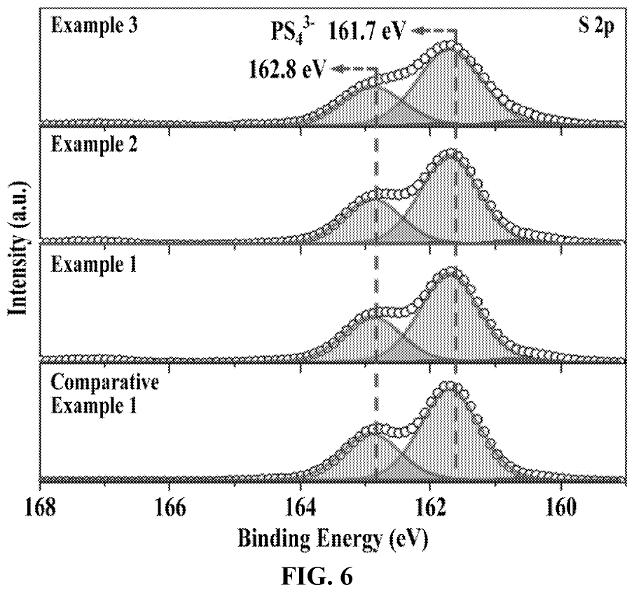

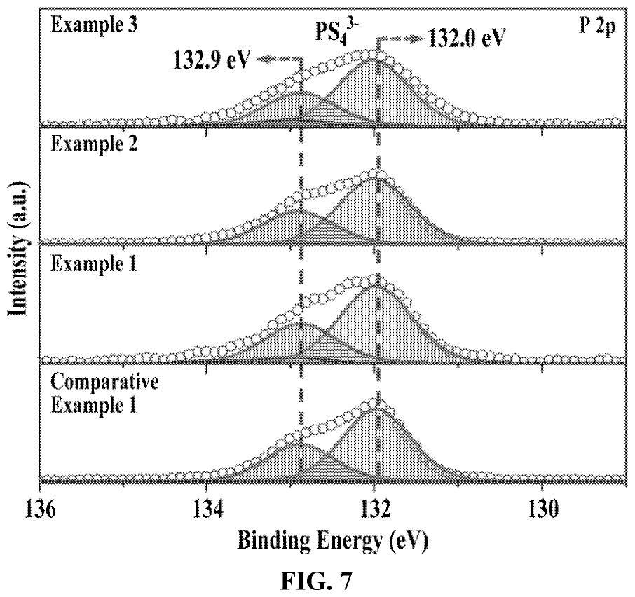

FIG. 6 is a set of graphs illustrating the result of X-ray photoelectron spectroscopy (XPS) analysis on the S 2p region of the solid electrolyte according to Comparative Example 1 and the composite solid electrolytes according to Examples 1 to 3, and FIG. 7 is a set of graphs illustrating the results of XPS analysis on the P 2p region of the solid electrolyte according to Comparative Example 1 and the composite solid electrolytes according to Examples 1 to 3.

Referring to FIGS. 6 and 7, in the solid electrolyte according to Comparative Example 1, the PS₄³⁻ bonding of the existing Li₆PS₅Cl can be confirmed in S 2p (161.7 eV, 162.8 eV) and P 2p (132.0 eV, 132.9 eV), and it can be confirmed that there is no significant difference in the bonding structure of the composite solid electrolytes according to Examples 1 to 3 due to the introduction of the functional polymer.

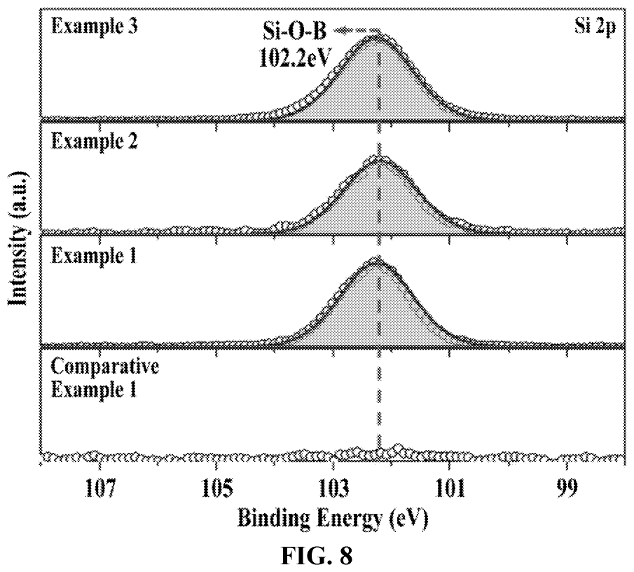

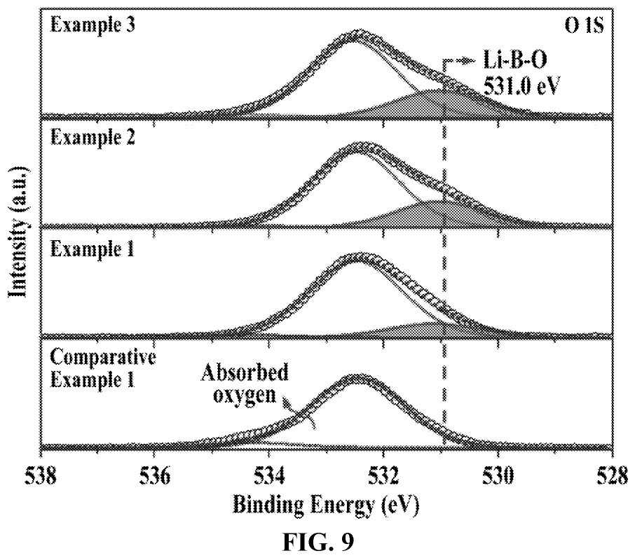

FIG. 8 is a set of graphs illustrating the results of X-ray Photoelectron Spectroscopy (XPS) analysis on the Si 2p region of the solid electrolyte according to Comparative Example 1 and the composite solid electrolytes according to Examples 1 to 3, and FIG. 9 is a set of graphs illustrating the results of XPS analysis on the O 1s region of the solid electrolyte according to Comparative Example 1 and the composite solid electrolytes according to Examples 1 to 3.

Referring to FIGS. 8 and 9, in the composite solid electrolytes according to Examples 1 to 3, Si—O—B (102.2 eV) bonds and Li—O—B (531.0 eV) bonds can be confirmed due to the introduction of the shell part (e.g., functional coating layer) including the functional polymer, compared to the solid electrolyte according to Comparative Example 1.

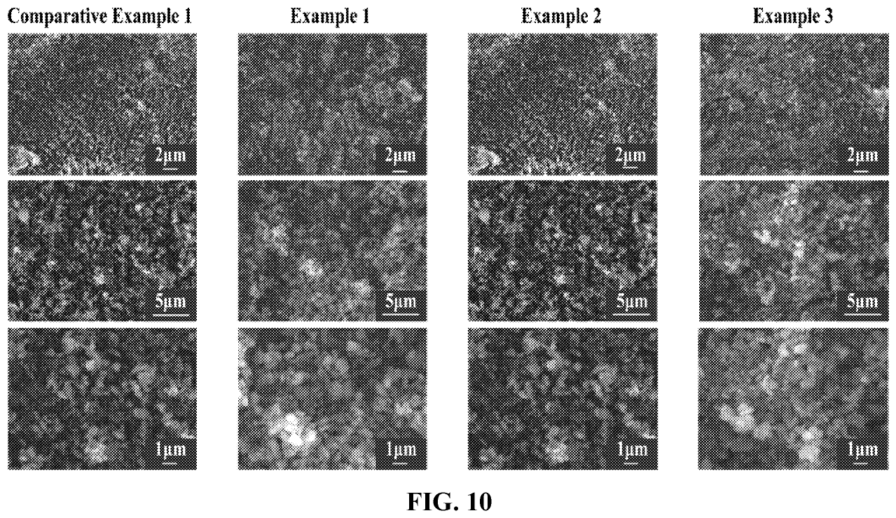

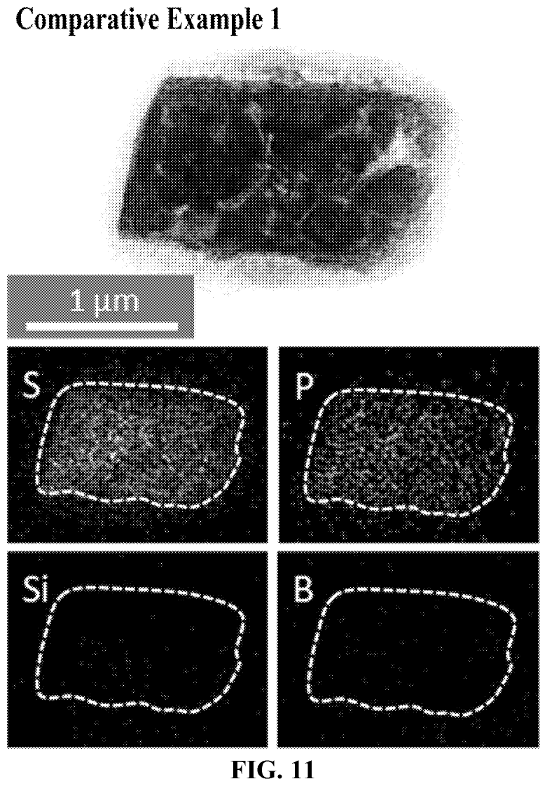

FIG. 10 is a set of images illustrating the results of Scanning Electron Microscope (SEM) analysis of the solid electrolyte according to Comparative Example 1 and the composite solid electrolytes according to Examples 1 to 3.

Referring to FIG. 10, it can be confirmed that there is no significant difference in surface morphology even when the shell part including the functional polymer is introduced into the composite solid electrolytes according to Examples 1 to 3, compared to the solid electrolyte according to Comparative Example 1.

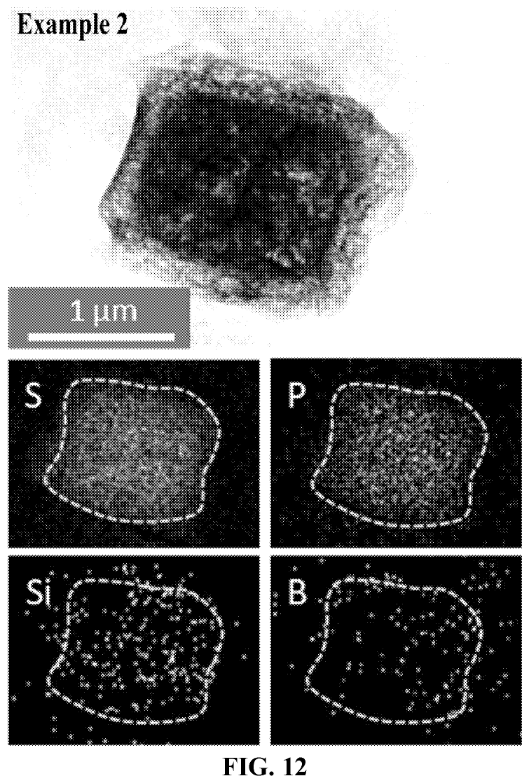

FIG. 11 is a set of images illustrating the results of High-Resolution Transmission Electron Microscopy (HRTEM) and Energy Dispersive Spectroscopy (EDS) analysis of the solid electrolyte according to Comparative Example 1, and FIG. 12 is a set of images illustrating the results of HRTEM and EDS analysis of the composite solid electrolyte according to Example 2.

Referring to FIGS. 11 and 12, it can be confirmed that Si and B elements are distributed in the composite solid electrolyte according to Example 2 due to the shell part including the functional polymer, compared to the solid electrolyte according to Comparative Example 1.

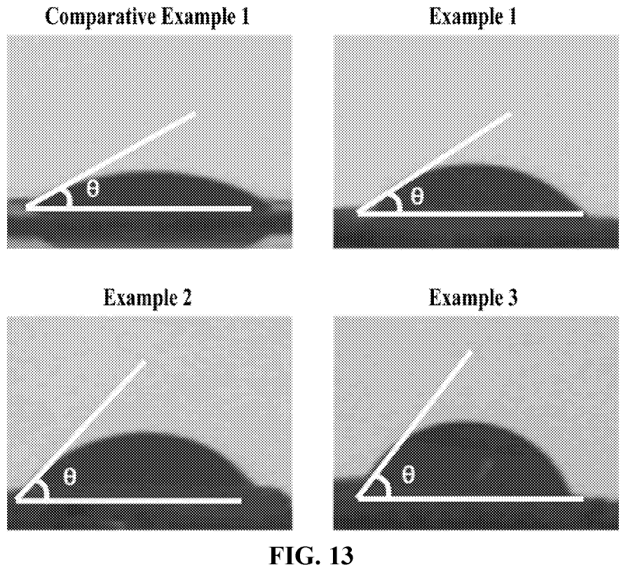

FIG. 13 is a set of images illustrating water contact angle measurement results of the solid electrolyte according to Comparative Example 1 and the composite solid electrolytes according to Examples 1 to 3.

Table 2 shows the water contact angle measurement results of the solid electrolyte according to Comparative Example 1 and the composite solid electrolytes according to Examples 1 to 3.

TABLE 2

| | Comparative | | | |
|---|---|---|---|---|
| | Example 1 | Example 1 | Example 2 | Example 3 |
| θ | 25.4° | 44.7º | 47.8° | 61.1° |

Referring to FIG. 13 and Table 2, it can be confirmed that the hydrophobic properties of the composite solid electrolytes according to Examples 1 to 3 are improved compared to the solid electrolyte according to Comparative Example 1.

In particular, in the composite solid electrolytes according to Examples 1 to 3, it can be confirmed that the hydrophobic properties of the solid electrolyte are improved as the water contact angle increases with an increase in the content of the functional polymer.

### [Experimental Example 2] Evaluation of Hydrogen Sulfide Generation Amount

100 mg of each of the solid electrolyte prepared in Comparative Example 1, the composite solid electrolytes prepared in Examples 1 to 3 were pressurized with a pressure of 2.5 tons and processed into a pellet shape.

Each of the pellet-shaped samples prepared using the solid electrolyte prepared in Comparative Example 1 and the composite solid electrolytes prepared in Examples 1 to 3 was placed in a 2 L desiccator, which was then sealed after installing a hydrogen sulfide gas concentration meter. All experimental procedures were conducted in a dry room environment with a dew point temperature of −50 °C or lower. Next, air controlled at a relative humidity (RH) of 50% was introduced into the desiccator and the composite solid electrolytes were exposed for a certain period of time. The concentration of hydrogen sulfide gas generated for 1 hour was measured and recorded.

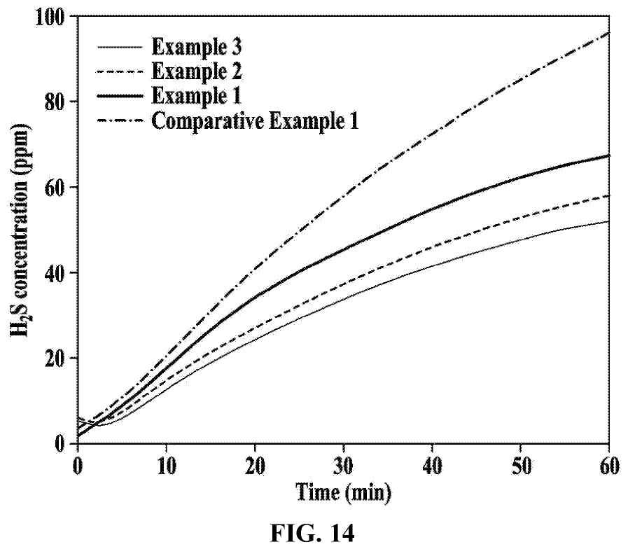

FIG. 14 is a set of graphs illustrating the results of evaluating the hydrogen sulfide generation amount for the solid electrolyte according to Comparative Example 1 and the composite solid electrolytes according to Examples 1 to 3.

Table 3 shows the experimental result values of FIG. 14.

TABLE 3

| | Hydrogen sulfide (HS) |
|---|---|
| | detection amount (ppm) |
| Comparative Example 1 | 96.1 |
| Example 1 | 67.2 |
| Example 2 | 57.9 |
| Example 3 | 52.1 |

Referring to FIG. 14 and Table 3, it can be confirmed that in the composite solid electrolytes according to Examples 4 to 6, the generation amount of hydrogen sulfide decreases due to the blocking of moisture contact through the shell part including the functional polymer, compared to the solid electrolyte according to Comparative Example 1.

### [Experimental Example 3] Evaluation of Ionic Conductivity

A general powder pressure cell was used, and 32 mg of the solid electrolyte according to Comparative Example 1, the composite solid electrolytes according to Examples 1 to 3, and the composite solid electrolytes after exposure to moisture were pressurized with a pressure of 1 ton to be processed into a pellet shape. Thereafter, a torque of 11 Nm was applied to fasten the pressure cell.

The ionic conductivity was evaluated through AC impedance measurement using the manufactured pressure cell. All processes were evaluated at room temperature and conducted in a dry room environment with a dew point temperature of −50 °C or lower.

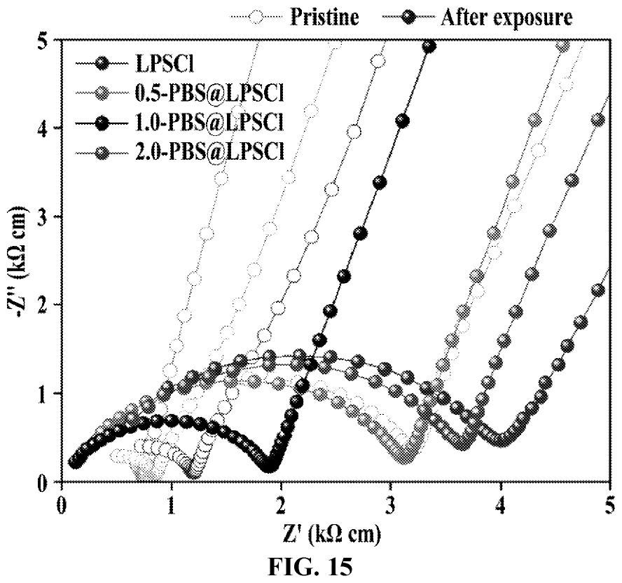

FIG. 15 is a set of graphs illustrating the ionic conductivity evaluation results of the solid electrolyte according to Comparative Example 1 and the composite solid electrolytes according to Examples 1 to 3 before and after exposure to moisture (relative humidity of 50%).

Table 4 shows the experimental result values of FIG. 15.

TABLE 4

| | Ionic conductivity (mS cm⁻¹) | | |
|---|---|---|---|
| | Before moisture | After moisture | Retention rate |
| | exposure | exposure | (%) |
| Comparative | 1.36 | 0.25 | 18.4 |
| Example 1 | | | |
| Example 1 | 1.16 | 0.32 | 27.6 |
| Example 2 | 0.83 | 0.53 | 63.9 |
| Example 3 | 0.31 | 0.28 | 90.3 |

Referring to FIG. 15 and Table 4, it can be confirmed that the moisture stability of the composite solid electrolytes according to Examples 1 to 3 is effectively improved due to the shell part including the functional polymer, compared to the solid electrolyte according to Comparative Example 1.

In particular, in the composite solid electrolytes according to Examples 1 to 3, it can be confirmed that the ionic conductivity retention rate after moisture exposure improves as the content of the functional polymer increases.

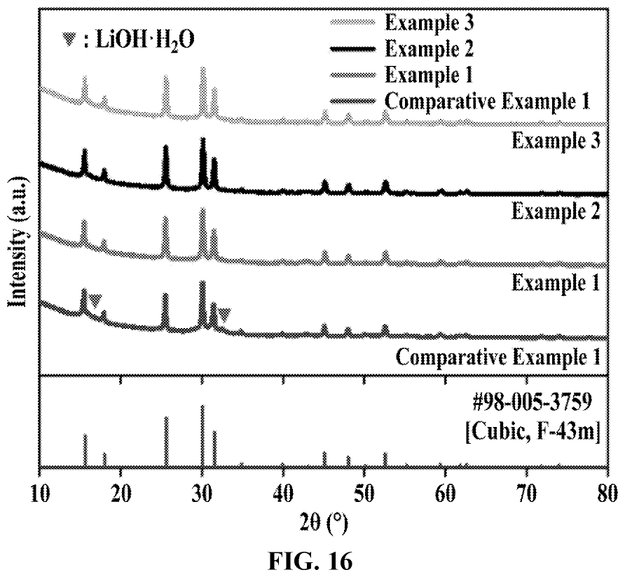

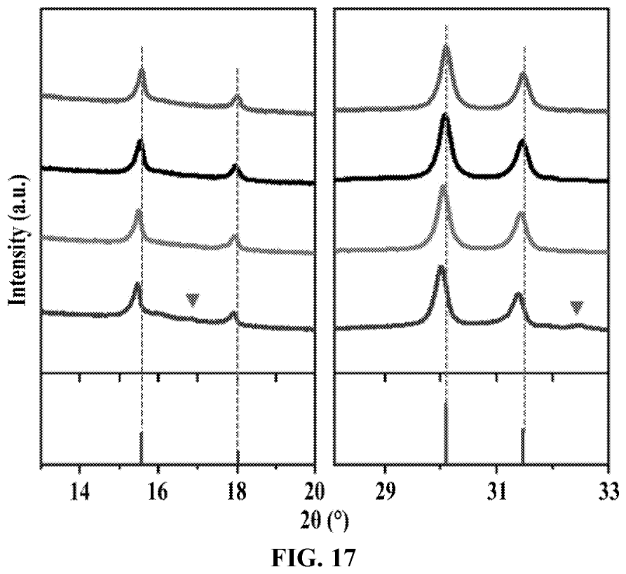

FIG. 16 is a set of graphs illustrating the results of X-ray diffraction analysis of the solid electrolyte according to Comparative Example 1 and the composite solid electrolytes according to Examples 1 to 3 after 1 hour of moisture exposure at a relative humidity of 50%, and FIG. 17 is a set of enlarged graphs illustrating the results of X-ray diffraction analysis of the solid electrolyte according to Comparative Example 1 and the composite solid electrolytes according to Examples 1 to 3 after 1 hour of moisture exposure at a relative humidity of 50%.

Referring to FIGS. 16 and 17, it can be confirmed that, in the case of the solid electrolyte according to Comparative Example 1, peak shifts due to structural changes following moisture exposure and the formation of LiOH·H₂O impurities occurred.

On the other hand, in the case of the composite solid electrolytes according to Examples 1 to 3, the moisture stability is improved as the content of the functional polymer increases, confirming that the structural change due to moisture exposure is insignificant.

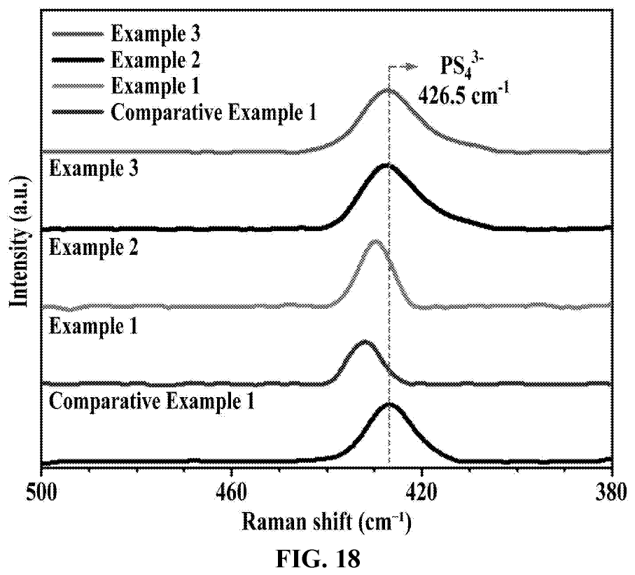

FIG. 18 is a set of graphs illustrating the results of Raman spectrum analysis of the solid electrolyte according to Comparative Example 1 and the composite solid electrolytes according to Examples 1 to 3 after being left for 1 hour at a relative humidity of 50%.

Referring to FIG. 18, it was confirmed that, in the case of the solid electrolyte according to Comparative Example 1, the PS₄³⁻ peak shifted (426.5→432 cm⁻¹) compared to before moisture exposure, and in the case of the composite solid electrolytes according to Examples 1 to 3, they include the shell part including the functional polymer, so that the moisture stability is improved, confirming that the degree of peak shift is reduced.

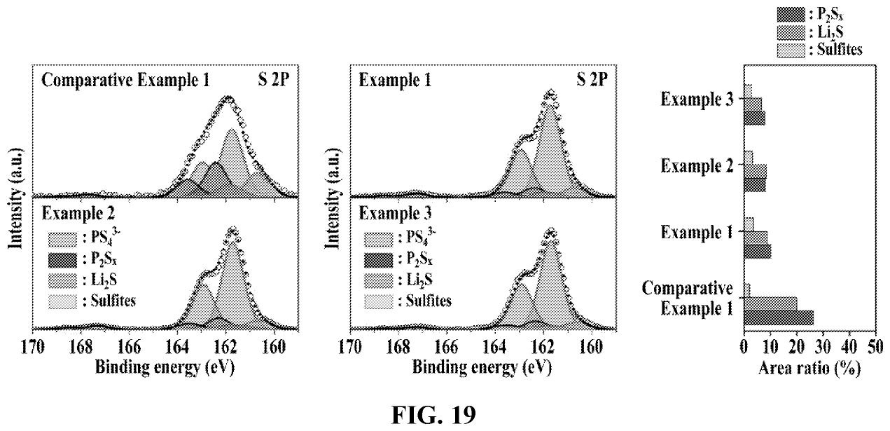

FIG. 19 is a set of graphs illustrating the results of X-ray photoelectron spectroscopy (XPS) analysis on the S 2p region of the solid electrolyte according to Comparative Example 1 and the composite solid electrolytes according to Examples 1 to 3 after being left for 1 hour at a relative humidity of 50%, and the degree of impurity generation represented by the area ratio of the corresponding peaks.

Referring to FIG. 19, in the case of the composite solid electrolytes according to Examples 1 to 3, the moisture stability is improved as they include the shell part including the functional polymer, confirming that the generation of impurities such as P₂Sₓ, Li₂S, and sulfites caused by the decomposition of the solid electrolyte is reduced, compared to the solid electrolyte according to Comparative Example 1.

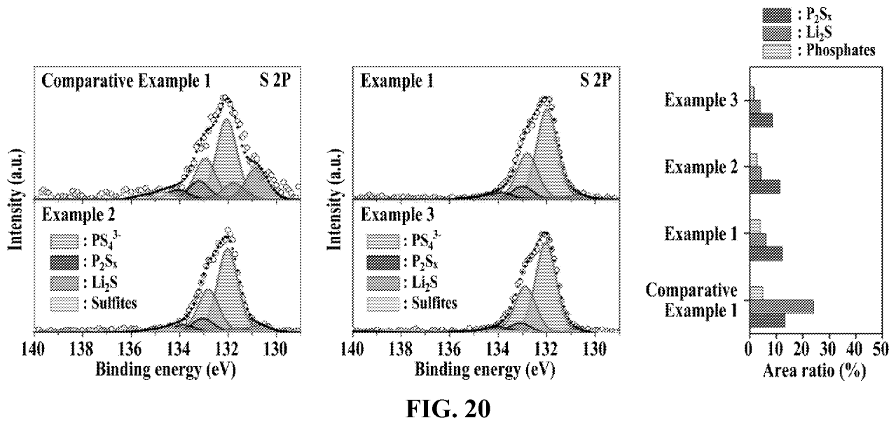

FIG. 20 is a set of graphs illustrating the results of X-ray photoelectron spectroscopy (XPS) analysis on the P 2p region of the solid electrolyte according to Comparative Example 1 and the composite solid electrolytes according to Examples 1 to 3 after being left for 1 hour at a relative humidity of 50%, and the degree of impurity generation represented by the area ratio of the corresponding peaks.

Referring to FIG. 20, in the case of the composite solid electrolytes according to Examples 1 to 3, the moisture stability is improved as they include the shell part including the functional polymer, confirming that the generation of impurities such as P₂Sₓ, Li₂P, and phosphates caused by the decomposition of the solid electrolyte is reduced, compared to the solid electrolyte according to Comparative Example 1.

### [Experimental Example 4] Evaluation of All-Solid-State Battery

Electrochemical evaluation was performed using an all-solid-state battery in the form of a powder pressure cell manufactured according to Experimental Example 3. All of the processes were performed in a dry room environment with a dew point temperature of −50 °C or lower. The voltage range for charge and discharge was set to 1.9-3.7 V vs. In—Li/Li⁺, and CV 10% was applied at the end of the charge. After performing 3 cycles of charge and discharge at 0.05C, output characteristic evaluation in the form of 0.1C-0.1C/0.2C/0.5C/1C/2C/0.2C charge and discharge, and 1C-1C lifespan characteristic evaluation were performed. All of the electrochemical characteristic evaluations were performed at room temperature (30 °C).

### Comparative Example 2

A cathode composite for electrochemical evaluation of an all-solid-state battery was prepared using the manufactured composite solid electrolyte and the moisture-exposed composite solid electrolyte. A powder-type cathode composite was prepared by mixing NCM with 90% Ni, the solid electrolyte according to Comparative Example 1, and a Super C conductive material at a weight ratio of 85:14:1.

### Example 4-1

A cathode composite for electrochemical evaluation of an all-solid-state battery was prepared using the manufactured composite solid electrolyte and the moisture-exposed composite solid electrolyte. A powder-type cathode composite was prepared by mixing NCM with 90% Ni, the composite solid electrolyte according to Example 1, and a Super C conductive material at a weight ratio of 85:14:1.

### Example 4-2

It was prepared in the same manner as in Example 4-1, except that the composite solid electrolyte according to Example 2 was used.

### Example 4-3

It was prepared in the same manner as in Example 4-3, except that the composite solid electrolyte according to Example 3 was used.

### Comparative Example 3

For the intermediate layer solid electrolyte, Li₆PS₅Cl with a particle size of about 7 μm was used, and for the anode, an indium (In) with a diameter of 9 mm and a lithium (Li) of 4 mm were composited and used.

A general powder pressure cell was used, and a pressure of 2.5 tons was applied to 100 mg of the intermediate layer solid electrolyte to be processed into a pellet shape. Thereafter, 10 mg of the cathode composite according to Comparative Example 2 was introduced to one surface of the solid electrolyte, and a pressure of 3.5 tons was applied to form a cathode layer. After introducing Li—In to the other surface to form an anode layer, a torque of 11 Nm was applied to fasten the pressure cell, thereby manufacturing an all-solid-state battery.

### Example 5-1

For the intermediate layer solid electrolyte, Li₆PS₅Cl with a particle size of about 7 μm was used, and for the anode, an indium (In) with a diameter of 9 mm and a lithium (Li) of 4 mm were composited and used.

A general powder pressure cell was used, and a pressure of 2.5 tons was applied to 100 mg of the intermediate layer solid electrolyte to be processed into a pellet shape. Thereafter, 10 mg of the cathode composite according to Example 4-1 was introduced to one surface of the solid electrolyte, and a pressure of 3.5 tons was applied to form a cathode layer. After introducing Li—In to the other surface to form an anode layer, a torque of 11 Nm was applied to fasten the pressure cell, thereby manufacturing an all-solid-state battery.

### Example 5-2

It was prepared in the same manner as in Example 4-1, except that the cathode composite according to Example 4-2 was used.

### Example 5-3

It was prepared in the same manner as in Example 4-3, except that the cathode composite according to Example 4-3 was used.

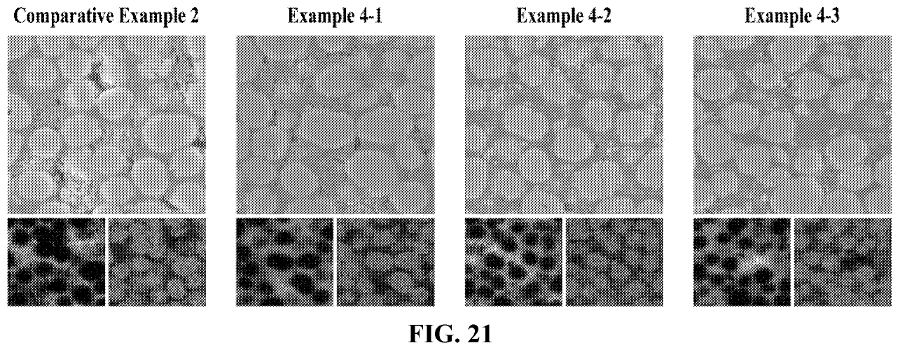

FIG. 21 illustrates the results of cross-sectional SEM analysis of the cathode composite according to Comparative Example 2 and the cathode composites according to Examples 4-1 to 4-3.

Referring to FIG. 21, it can be confirmed that, compared to the cathode composite according to Comparative Example 2, the cathode composites according to Examples 4-1 to 4-3 have improved contact between the cathode and the solid electrolyte, so that the pores between the cathode and the solid electrolyte are reduced.

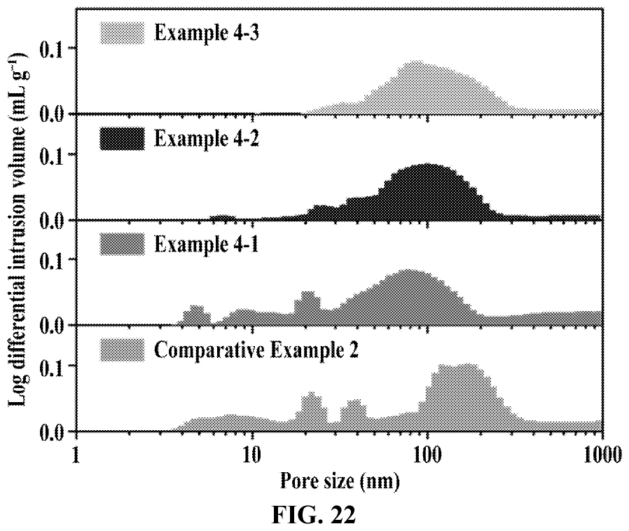

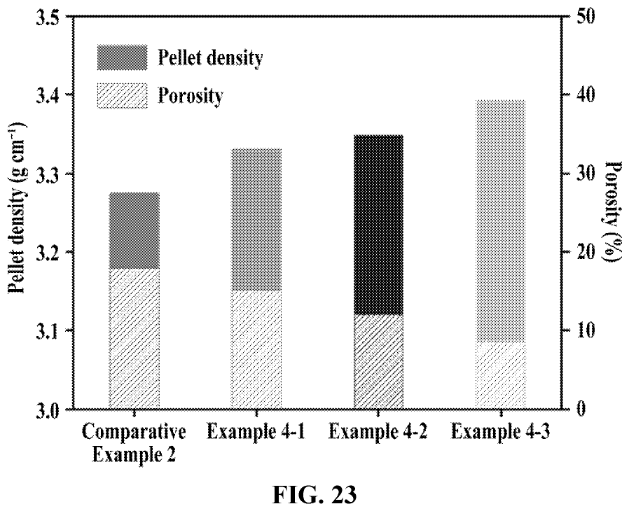

FIG. 22 illustrates the results of mercury porosity analysis after processing the cathode composite according to Comparative Example 2 and the cathode composites according to Examples 4-1 to 4-3 into a pellet shape, and FIG. 23 illustrates the results of pellet density analysis.

Referring to FIGS. 22 and 23, it can be confirmed that the contact between the cathode and the solid electrolyte is improved in the cathode composites according to Examples 4-1 to 4-3 due to the introduction of the shell part including the functional polymer, compared to the cathode composite according to Comparative Example 2, so that the pore size inside the cathode composite pellet decreases, and the pellet density increases while the porosity decreases.

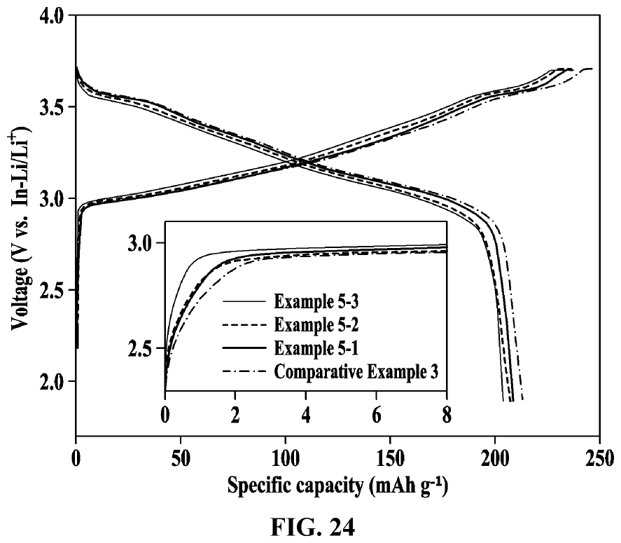

FIG. 24 illustrates the results of evaluating the electrochemical properties of the all-solid-state battery according to Comparative Example 3 and the all-solid-state batteries according to Examples 5-1 to 5-3.

Table 5 shows the experimental result values of FIG. 24.

TABLE 5

| | Charge | Discharge | Coulombic efficiency |
|---|---|---|---|
| | (mAh/g) | (mAh/g) | (%) |
| Comparative | 245.7 | 212.9 | 86.7 |
| Example 4 | | | |
| Example 5-1 | 232.9 | 203.8 | 87.5 |
| Example 5-2 | 236 | 208.6 | 88.4 |
| Example 5-3 | 235.6 | 207.1 | 87.9 |

Referring to FIG. 24 and Table 5, it can be confirmed that the initial efficiency is improved and initial side reactions are suppressed in the all-solid-state batteries according to Examples 5-1 to 5-3, compared to the all-solid-state battery according to Comparative Example 3.

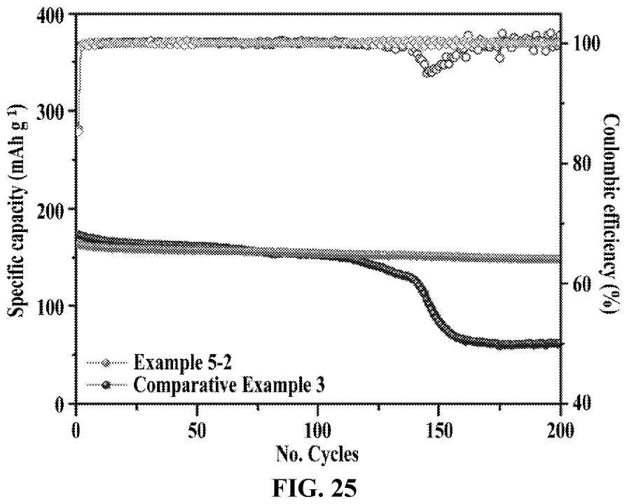

FIG. 25 is a set of graphs illustrating the results of evaluating the lifespan characteristics of the all-solid-state battery according to Comparative Example 3 and the all-solid-state batteries according to Examples 5-1 to 5-3.

Table 6 shows the experimental result values of FIG. 25.

TABLE 6

| | 100^{th} discharge capacity | 100^{th} capacity retention rate |
|---|---|---|
| | (mAh/g) | (%) |
| Comparative | 62.1 | 35.9 |
| Example 3 | | |
| Example 5-2 | 148 | 90.8 |

Referring to FIG. 25 and Table 6, it can be seen that the all-solid-state battery according to Comparative Example 3 exhibits a capacity retention rate of 35.9%, while the all-solid-state batteries according to Examples 5-1 to 5-3 exhibit a capacity retention rate of about 90.8%.

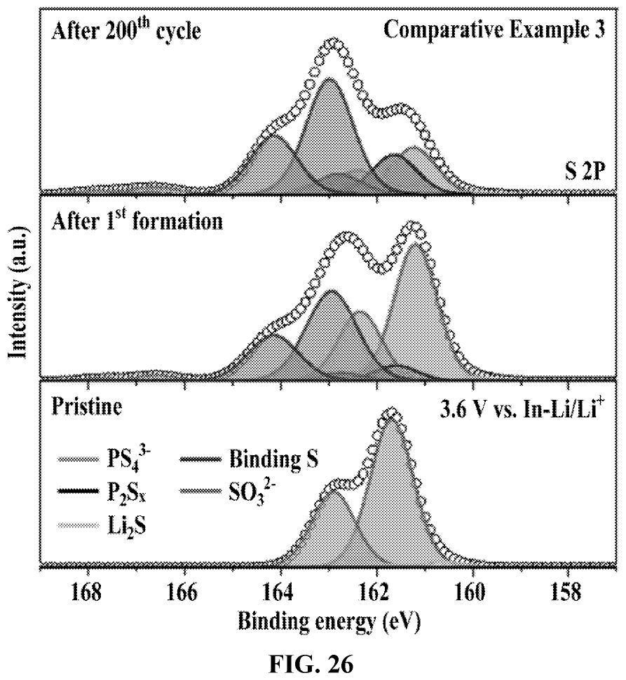

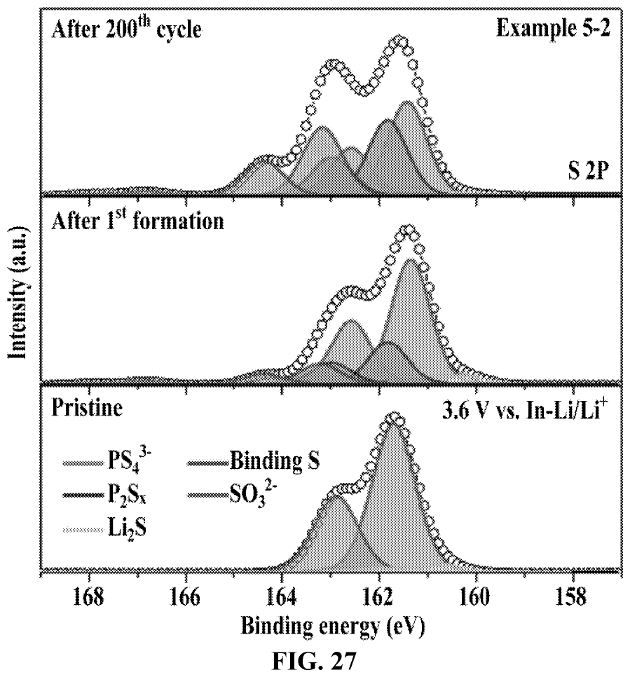

FIG. 26 is a set of graphs illustrating the results of X-ray photoelectron spectroscopy (XPS) analysis on the S 2p region at the initial stage, after the 1st cycle, and after the 100th cycle of the all-solid-state battery according to Comparative Example 3, and FIG. 27 is a set of graphs illustrating the results of X-ray photoelectron spectroscopy (XPS) analysis on the S 2p region at the initial stage, after the 1st cycle, and after the 100th cycle of the all-solid-state battery according to Example 5-2.

Referring to FIG. 26, compared to the all-solid-state battery according to Comparative Example 3, the all-solid-state battery according to Example 5-2 has improved interfacial stability due to the introduction of the shell part including the functional polymer, so that, when it comes into contact with the cathode material, the formation of a space charge layer is suppressed, reducing the degree of peak shift (ΔB.E=−0.50 eV→−0.34 eV) and reducing the degree of impurity formation.

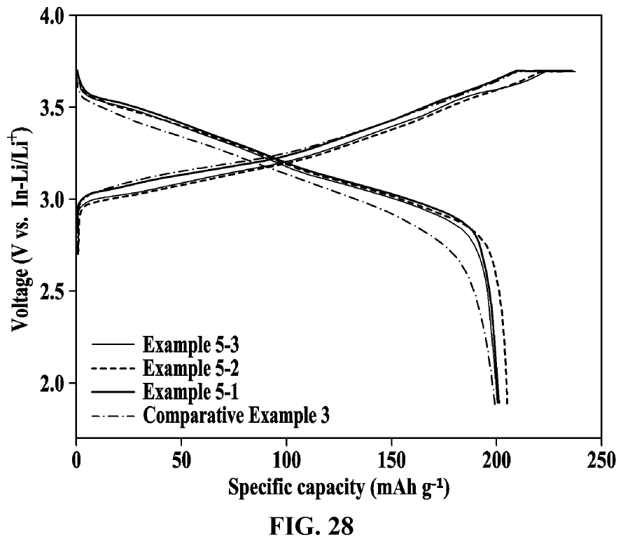

FIG. 28 is a set of graphs illustrating the results of evaluating the electrochemical properties of the all-solid-state battery according to Comparative Example 3 and the all-solid-state batteries according to Examples 5-1 to 5-3 after being left for 1 hour at a relative humidity of 50%. Table 7 shows the experimental result values of FIG. 28.

TABLE 7

| | Charge | Discharge | Coulombic efficiency |
|---|---|---|---|
| | (mAh/g) | (mAh/g) | (%) |
| Comparative | 236.7 | 199.3 | 84.2 |
| Example 3 | | | |
| Example 5-1 | 233.9 | 200.4 | 85.7 |
| Example 5-2 | 234.6 | 205.1 | 87.4 |
| Example 5-3 | 231.3 | 200.1 | 86.5 |

Referring to FIG. 28 and Table 7, it can be confirmed that the initial discharge capacity and efficiency are improved in the all-solid-state batteries according to Examples 5-1 to 5-3, compared to the all-solid-state battery according to Comparative Example 3.

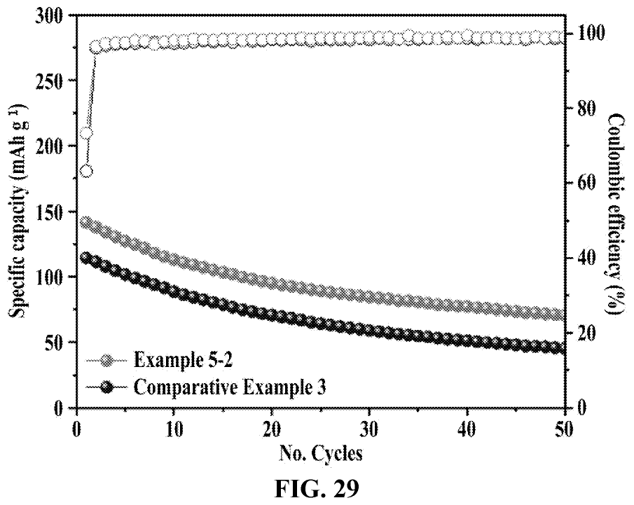

FIG. 29 is a set of graphs illustrating the results of evaluating the lifespan characteristics of the all-solid-state battery according to Comparative Example 3 and the all-solid-state battery according to Example 5-2 after being left for 1 hour at a relative humidity of 50%.

Table 8 shows the experimental result values of FIG. 29.

TABLE 8

| | 50^{th} discharge capacity | 50^{th} capacity retention rate |
|---|---|---|
| | (mAh/g) | (%) |
| Comparative | 45.4 | 39.7 |
| Example 3 | | |
| Example 5-2 | 70.4 | 49.8 |

Referring to FIG. 29 and Table 8, it can be confirmed that the all-solid-state battery according to Example 5-2 has an increased discharge capacity and an improved capacity retention rate after 50 cycles, compared to the all-solid-state battery according to Comparative Example 3.

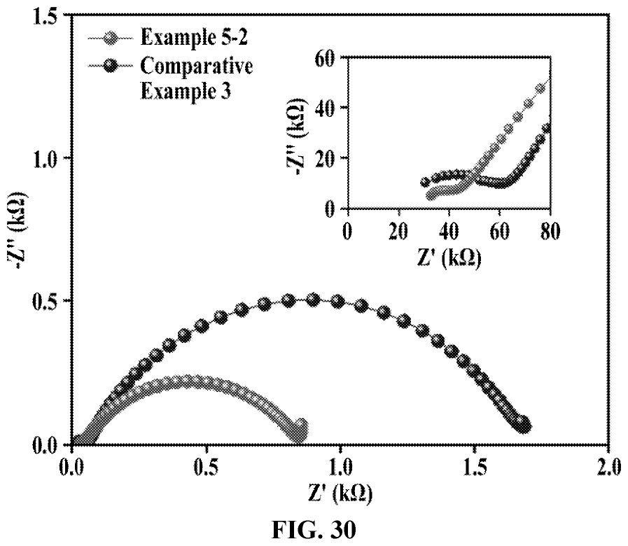

FIG. 30 is a set of graphs illustrating the results of impedance analysis performed after evaluating the lifespan characteristics of the all-solid-state battery according to Comparative Example 3 and the all-solid-state battery according to Example 5-2 after being left for 1 hour at a relative humidity of 50%.

Referring to FIG. 30, it can be confirmed that the resistance after cycling of the all-solid-state battery according to Example 5-2 decreases according to the improvement in moisture stability and interfacial stability, compared to the all-solid-state battery according to Comparative Example 3.

According to an embodiment of the present disclosure, a composite solid electrolyte capable of suppressing a decrease in ionic conductivity due to structural damage even when the composite solid electrolyte is exposed to moisture can be produced by compositely coating a hydrophobic polymer and an ion-conductive material on the surface of sulfide-based solid electrolyte particles, and a method of producing the composite solid electrolyte can be provided.

In addition, according to an embodiment of the present disclosure, it is possible to provide a composite solid electrolyte and a method for producing the same, which can further facilitate the storage and manufacturing processes of the solid electrolyte by introducing a functional polymer having hydrophobicity and ion conductivity to the surface of the sulfide-based solid electrolyte, thereby blocking contact between the solid electrolyte and moisture, suppressing hydrogen sulfide gas generation, and minimizing ionic conductivity loss.

According to an embodiment of the present disclosure, it is possible to provide a cathode composite, and an all-solid-state battery including the same, which can maintain chemical stability and improve contact between particles within an electrode when the composite solid electrolyte is composited with a commercial cathode material and applied to an all-solid-state battery.

Further, according to an embodiment of the present disclosure, it is possible to provide a cathode composite, and an all-solid-state battery including the same, which can improve the electrochemical performance of the all-solid-state battery by enhancing the interfacial stability between the cathode and the solid electrolyte through the composite solid electrolyte to which a shell part including a functional polymer is applied.

Although the present disclosure has been described through limited examples and drawings, the present disclosure is not intended to be limited to the examples. Those skilled in the art will appreciate that various modifications, additions and substitutions are possible, without departing from the scope and spirit of the disclosure. Therefore, the scope of the present disclosure should not be limited to the described examples, but should be defined not only by the claims described below but also by equivalents of these claims.

What is claimed is:

1. A composite solid electrolyte, comprising:
a core part comprising a sulfide-based solid electrolyte; and
a shell part coated on a surface of the core part and comprising a functional polymer,
wherein the functional polymer comprises a reaction product of a hydrophobic polymer and an ion-conductive material.

2. The composite solid electrolyte of claim 1, wherein the functional polymer comprises a Si—O-A (A comprises a trivalent cation) bond in a polymer matrix comprising the hydrophobic polymer.

3. The composite solid electrolyte of claim 1, wherein the functional polymer comprises a Li-A-O (A comprises a trivalent cation) bond in a polymer matrix comprising the hydrophobic polymer.

4. The composite solid electrolyte of claim 1, wherein the sulfide-based solid electrolyte comprises a compound represented by Formula 1 below:
LiₐP_{b}S_{c}X_{d} [Formula 1]
where X comprises at least one of Cl, Br, I, 0≤a≤12, 0≤b≤6, 0≤c≤12, and 0≤d≤9.

5. The composite solid electrolyte of claim 1, wherein the hydrophobic polymer comprises a compound represented by Formula 2 below:
CH₃[Si(CH₃)₂O]ₙOSi(CH₃)₃ [Formula 2]
where n is an integer of 1 to 1000.

6. The composite solid electrolyte of claim 1, wherein the ion-conductive material comprises a compound represented by Formula 3 below:
H₃AO₃ [Formula 3]
where A comprises a trivalent cation.

7. The composite solid electrolyte of claim 1, wherein a content of the functional polymer is 0.1% by weight to 10% by weight based on the sulfide-based solid electrolyte.

8. A cathode composite, comprising:
a cathode active material;
the composite solid electrolyte according to claim 1; and
a conductive material.

9. The cathode composite according to claim 8, wherein the cathode composite has a pellet density of 3.3 to 3.4 g cm⁻³.

10. An all-solid-state battery, comprising:
the cathode composite according to claim 8;
an anode; and
a solid electrolyte disposed between the cathode composite and the anode.

11. A method of producing a composite solid electrolyte, the method comprising:
preparing a sulfide-based electrolyte;
producing a functional polymer solution comprising a functional polymer by reacting a hydrophobic polymer with an ion-conductive material in a solvent; and
producing a composite solid electrolyte by reacting the sulfide-based electrolyte with the functional polymer,
wherein, in the producing of the composite solid electrolyte, a shell part comprising the functional polymer is coated on a surface of a core part comprising the sulfide-based solid electrolyte.

12. The method according to claim 11, wherein the producing of the composite solid electrolyte comprises:
producing a composite solid electrolyte solution by stirring the functional polymer solution and the sulfide-based electrolyte; and
heat-treating the composite solid electrolyte solution.

13. The method according to claim 12, wherein the heat-treating of the composite solid electrolyte solution is performed at a temperature of 80 °C to 200 °C in a vacuum atmosphere.
